(19) United States
(12) Patent Application Publication
(10) Pub. No.: US 2010/0010695 A1
(43) Pub. Date: Jan. 14, 2010

(54) HEADING REFERENCE SYSTEM WITH REMOTE-MOUNTED SENSOR

(75) Inventor: Daniel L. Oomkes, Grand Rapids, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: L-3 COMMUNICATIONS AVIONICS SYSTEMS, INC., Grand Rapids, MI (US)

(21) Appl. No.: 12/373,597

(22) PCT Filed: Jul. 16, 2007
(86) PCT No.: PCT/US07/73591

§ 371 Date: Jan. 13, 2009

Related U.S. Application Data
(60) Provisional application No. 60/807,622, filed on Jul. 18, 2006.

(51) Int. Cl. G01C 21/00; G06F 7/00

(52) U.S. Cl. 701/14; 701/200; 701/3

(57) ABSTRACT

A navigation system for an aircraft includes one or more wing-mounted sensors whose outputs are effected by the flexing of the wing during flight. The navigation system corrects for these errors using measurements of actual wing flex taken during an initial flight and thereafter assumed to be valid for all subsequent flights and for all aircraft using the same type of airframe. The actual measurements of wing flex define a wing flex correction factor that the navigation system may adjust during flight to reduce or remove residual errors. The wing flex correction factor accounts for all three types of possible wing flex: pitch, roll, and yaw flexing.

### CROSS-REFERENCE TO RELATED APPLICATIONS

This application claims priority to U.S. provisional application Ser. No. 60/807,622, filed Jul. 18, 2006, by Daniel Oomkes, entitled Heading Reference System with Remote-Mounted Sensor, the complete disclosure of which is hereby incorporated herein by reference.

### BACKGROUND OF THE INVENTION

The present invention relates to aircraft navigation systems, and more particularly to navigation sensors mounted in remote locations in the aircraft, such as the wings.

Navigation sensors are used onboard aircraft to determine such navigation data as pitch, roll, heading, altitude, speed, position, and other information. In some instances, one or more of these navigation sensors is mounted in the wing of an aircraft and the navigation data measured by the sensor is affected by the sensor's position in the wing. This is because the wing normally flexes during flight, which, in turn, causes the known angular relationship of the sensor with respect to the body of the aircraft, which serves as the base reference for the navigation system, to change. This change in the angular relationship between the wing-mounted sensor and the body of the aircraft can create navigational errors if left uncorrected.

Consider, for example, the case of a magnetometer. Magnetometers are conventionally used in aircraft heading systems for detecting the Earth's magnetic field and giving the pilot of the aircraft an indication of what direction he or she is flying in relative to the Earth's north magnetic pole. It is common to mount the magnetometer (or magnetometers) in a location on the aircraft remote from the engine (or engines) and any other major sources of magnetic fields in order to reduce potential interference such magnetic fields might have on the magnetometer readings. Typically, the outer portions of the wings are chosen as the location for mounting the magnetometers. Each magnetometer detects the strength of the Earth's magnetic field in three mutually perpendicular directions and outputs values corresponding to these strengths in each direction. These values are output according to a three-dimensional magnetometer frame of reference having X, Y, and Z axes.

In order for the navigation system onboard the aircraft to make meaningful use of the information output from the magnetometer, the navigation system typically must rotate the X, Y, and Z magnetometer measurements into a different frame of reference. One such useful frame of reference is a frame of reference defined by the body of the aircraft. By rotating the magnetometer information into the aircraft body frame of reference, information from other navigation sensors on board the aircraft, such as roll and pitch sensors, can be properly integrated with the magnetometer information because the other navigation sensors will either be mounted in alignment with the aircraft body frame of reference, or will have their outputs rotated to the body frame of reference.

A problem arises, however, when rotating the magnetometer data into the body frame of reference because the wing of the airplane, in which the magnetometer is positioned, will flex when the aircraft becomes airborne. This flexing of the wing will upset the known relationship between the magnetometer frame of reference and the body frame of reference because this known relationship is measured on the ground when the wing experiences no airborne flexing. As a result, calculations of heading made from the magnetometer data will typically be in error. Moreover, the heading calculation errors can be multiplied by a factor of three due to the vertical component of the Earth's magnetic field being roughly three times as strong as the horizontal component of the Earth's magnetic field. A wing which flexes upward during flight by one degree can therefore create three degrees of heading error in the magnetometer data because the magnetometer is sensing (when the wing flex is unaccounted for) vertical components of the Earth's magnetic field that are mistakenly being interpreted as horizontal components, and vice versa. In the case of two degrees of wing flex, the magnetometer heading error can be six degrees. In the case of even greater wing flex, the magnetometer heading error can continue to escalate by a multiple of three.

In the past, the problem of wing flex introducing errors into magnetometer-sensed headings has either been ignored or compensated for by sensors that detect the amount of wing flex. Ignoring the errors has its obvious disadvantages and is generally desirable to avoid. Using additional sensors, however, also suffers from disadvantages, including the need for extra labor to install the sensors and calibrate them, extra cost to build and purchase them, extra weight on the aircraft, extra space to accommodate them on the aircraft, and reduced reliability. These disadvantages illustrate the desirability of a new method for addressing the problems of wing flex as it relates to navigation sensors mounted in the wings, such as magnetometers.

### SUMMARY OF THE INVENTION

Accordingly, the present invention provides a system and method for accommodating wing flex navigational errors that substantially overcomes these and other disadvantages. The system and method utilize control algorithms that account for wing flex without the need for installing a separate sensor that measures wing flex. The system and method reduces the weight on the aircraft, the amount of labor involved in installing the system, and the potential for failures.

According to one aspect of the invention, a navigational reference system for an aircraft is provided. The navigational reference system includes a navigation sensor, an airborne sensor, and a controller. The navigation sensor is secured to one wing of the aircraft and adapted to output a navigation signal. The airborne sensor is adapted to determine when the aircraft becomes airborne, and the controller is adapted to use the signal from the navigation sensor to compute navigation information of the aircraft. The controller computes the navigation information of the aircraft using a first method when the airborne sensor determines the aircraft is on the ground, and the controller computes the navigation information of the aircraft using a second method when the airborne sensor determines the aircraft is airborne. The first method is different from the second method.

According to another aspect of the present invention, a method for determining navigation information, such as the heading of an aircraft, is provided. The method includes providing a navigation sensor, such as a magnetometer, mounted in the wing of the aircraft wherein the navigation sensor provides navigation data, such as a signal relating to a strength of the Earth's magnetic field. The method also includes defining a frame of reference fixed with respect to the navigation sensor and defining another frame of reference fixed with respect to the body of the aircraft. The method further includes transforming the signal from the navigation sensor in the navigation sensor's frame of reference to the body frame of reference using a wing flex correction factor. The wing flex correction factor accounts for flexing of the wing with respect to the body of the aircraft, and the wing flex correction factor is determined prior to the aircraft becoming airborne.

According to yet another aspect of the present invention, a heading reference system for an aircraft is provided. The heading reference system includes a magnetometer mounted in a wing of the aircraft and a controller. The magnetometer is adapted to sense the Earth's magnetic field and output a signal relating to a strength of the Earth's magnetic field. The magnetometer defines a frame of reference fixed with respect to itself. The controller is adapted to transform the signal from the magnetometer frame of reference to a body frame of reference using a wing flex correction factor. The body frame of reference is fixed with respect to the body of the aircraft, and the wing flex correction factor accounts for flexing of the wing with respect to the body of the aircraft. The wing flex correction factor is determined prior to the aircraft becoming airborne.

According to still other aspects of the invention, the wing flex correction factor may have both non-zero pitch and non-zero roll components. The airborne sensor may be an airspeed sensor that indicates the aircraft is airborne when the airspeed exceeds a defined threshold. The wing flex correction factor may be variable with respect to the airspeed, particularly when the airspeed is between an upper and lower threshold. When the airspeed exceeds the upper threshold, the wing flex correction factor may be held constant. A second magnetometer may be used in an opposite wing of the aircraft and the heading derived from the second magnetometer may be compared with the heading from the first magnetometer to adjust the wing flex correction factor.

The systems and methods of the present invention provide a cost-effective solution to the navigational problem of wing flex. The systems and methods of the present invention avoid the difficulties and disadvantages of the prior methods of addressing wing flex, such as the added weight and labor involved with using a sensor that measures wing flex. These and other advantages of the present invention will be apparent to one skilled in the art in light of the following specification when read in conjunction with the accompanying drawings.

### BRIEF DESCRIPTION OF THE DRAWINGS

FIG. 1 is a block diagram of the components of a navigation system according to one aspect of the present invention;

FIG. 2 is a block diagram illustrating the steps of a method for determining heading according to the navigation system of FIG. 1;

FIG. 3 is a plan view of an illustrative example of an aircraft to which the systems and methods of the present invention may be applied;

FIG. 4 is a front elevational view of the aircraft of FIG. 3;

FIG. 5 is simplified, front, elevational view of a body and wings of a generic aircraft;

FIG. 6 is an enlarged, front, elevational view of an outer portion of one of the wings of FIG. 5 illustrating the position of the wing when it has flexed in phantom;

FIG. 7 is a block diagram of the components of a navigation system according to another aspect of the present invention; and

FIG. 8 is a flow chart illustrating the steps for adjusting a wing flex correction factor during flight according to another aspect of the present invention.

### DETAILED DESCRIPTION OF THE PREFERRED EMBODIMENTS

The present invention will now be described with reference to the accompanying drawings wherein the reference numerals appearing in the text below correspond to like-numbered elements in the several drawings.

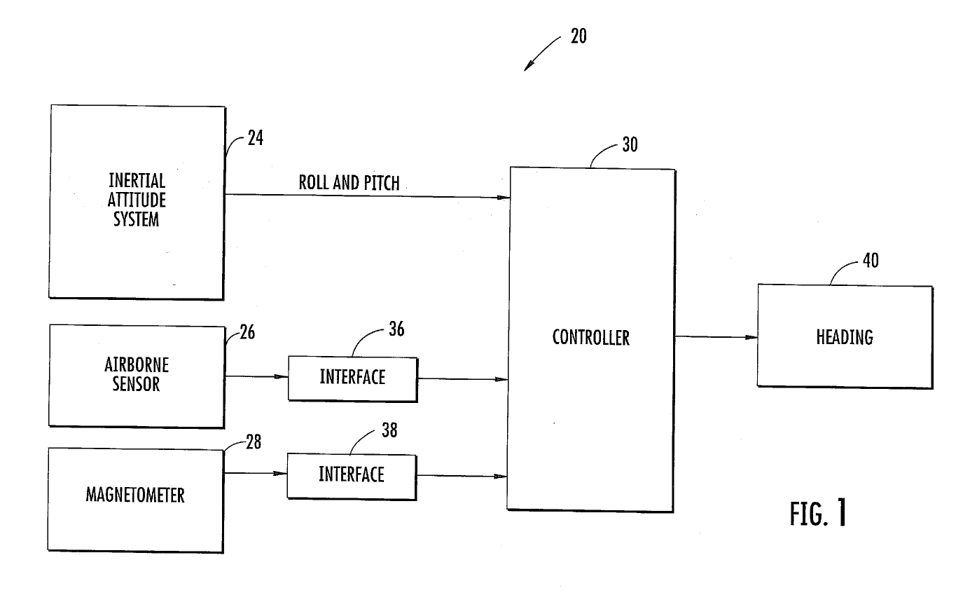

A navigation system 20 according to one aspect of the present invention is illustrated in block diagram form in FIG. 1. Navigation system 20 includes an inertial attitude system 24, an airborne sensor 26, and a magnetometer 28. Inertial attitude system 24 may be a conventional inertial attitude system that uses a plurality of inertial sensors, such as, but not limited to, gyroscopes to determine the attitude of the aircraft. This attitude information includes a calculation of the pitch and roll of the aircraft, which is passed from inertial attitude system 24 to a controller 30. Airborne sensor 26 passes a signal to controller 30 through interface 36 that provides an indication as to whether the aircraft is airborne or not. Magnetometer 28 detects the Earth's magnetic field in three orthogonal directions (X, Y, and Z) and passes those readings through interface 38 to controller 30. Controller 30 may be a microprocessor with associated memory, a series of microprocessors and associated memory, or any other electrical and electronic circuits capable of reading the outputs of inertial attitude system 24 and sensors 26 and 28 and processing those outputs to determine a heading 40 of the aircraft in the manner described below. Interfaces 36 and 38 are conventional interfaces for allowing controller 30 to communicate with sensors 26 and 28, and may comprise such things as Analog-to-Digital converters, buffers, and/or Universal Asynchronous Receiver-Transmitters (UARTs).

Controller 30 of navigation system 20 is programmed to calculate heading 40 in a manner that corrects for the navigational errors that would otherwise be introduced through the flexing of the aircraft's wings. Navigation system 20 accounts for this flexing of the aircraft's wings without the need for any additional sensors beyond those illustrated in FIG. 1. Thus, navigation system 20 accounts for the flexing of the wings without requiring any mechanical, or other type, of sensor that measures the actual amount of wing flex. This allows navigation system 20 to be installed more easily, makes it lighter, less expensive, and less prone to mechanical breakdown.

In broad overview, controller 30 accounts for the flexing of the aircraft's wings by using a wing flex correction factor that is derived from an initial measurement of the actual flex of the wing. This measurement is carried out once for a given airframe and the values of the measurement are stored and used by controller 30. In general, then, controller 30 operates under the assumption that the flexing of the wings for a given airframe will not vary appreciably from one flight to another, nor from one model of airplane to another model of airplane that uses the same airframe. Thus, navigation system 20 does not need to repeatedly measure the actual amount of wing flex, but instead can rely upon one or more measurements made in the past. This enables controller 30 to account for wing flex without the use of additional sensor components. If navigation system 20 is to be installed in an aircraft having an airframe whose wing flex values have not yet been measured, measurements of those wing flex values are taken, stored, and then used by controller 30 to account for wing flex in all subsequent flights and for all other aircraft models using the same airframe.

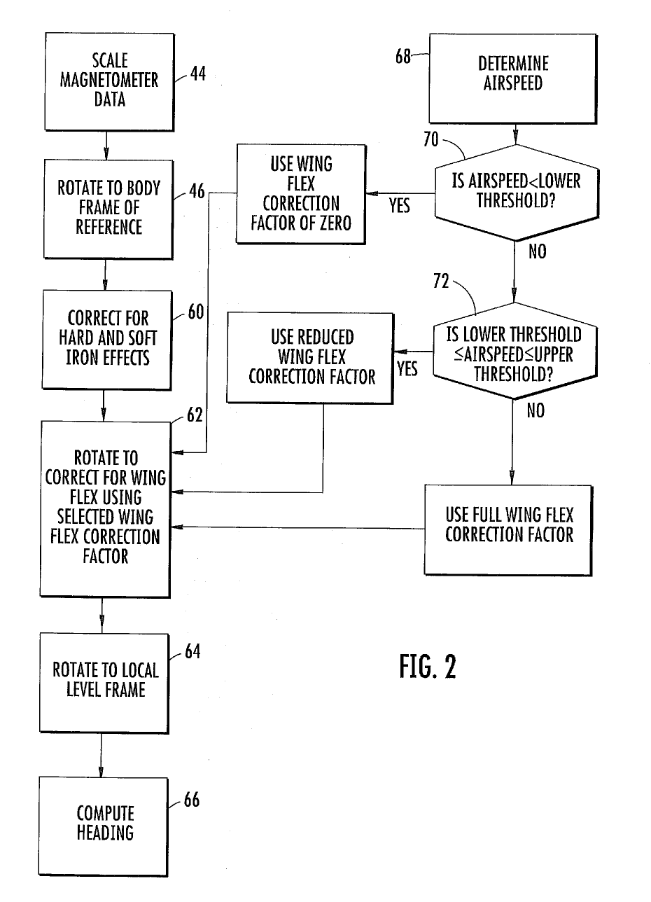

The specific steps followed by controller 30 to calculate heading in a manner that accounts for wing flex are illustrated in block diagram format in FIG. 2. These steps will now be described and explained with reference to both FIG. 2 and FIGS. 3-6. At step 44, controller 30 receives the raw output of magnetometer 28 (after passing through interface 38) and scales the output (which consists of X, Y, and Z measurements of the Earth's magnetic field) so that its values are expressed in whatever units are desirable. For example, controller 30 may scale the output of magnetometer 28 into units of gauss. This is accomplished by multiplying or dividing the output of magnetometer 28 by the appropriate scaling factor. The scaling of step 44 is an optional step and need not be performed in those situations where the output of magnetometer 28 is already expressed in the desired units. It will also be understood that the scaling of step 44 could be performed by interface 38, or some other device, before being fed into controller 30.

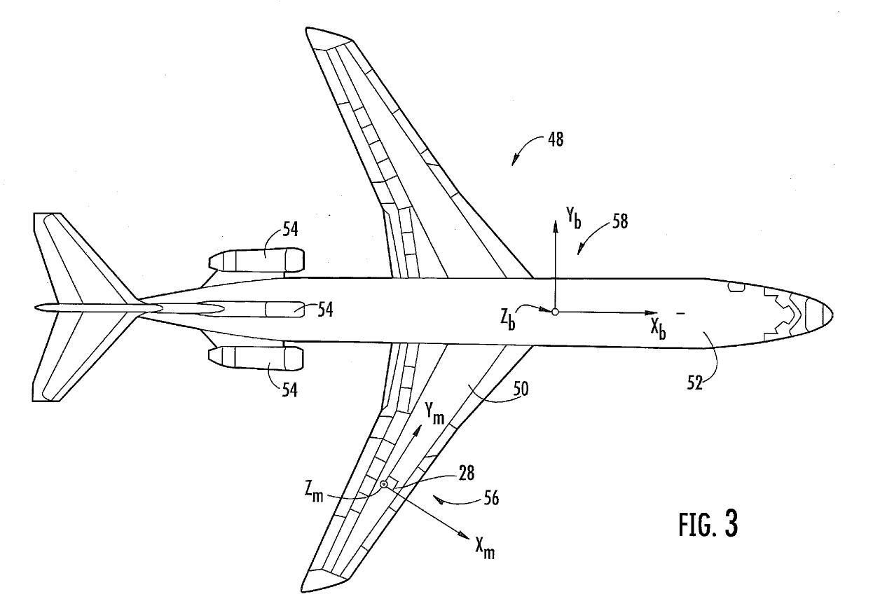

After the values output by magnetometer 28 have been scaled, these values are transformed in step 46 by rotating them into a body frame of reference that is fixed and aligned with respect to the body of the aircraft. While the process for carrying out this rotation is known and conventional, it will be described herein in more detail because it will provide the background for the detailed description of the manner in which controller 30 accounts for wing flex. In order to describe the rotation carried out in step 46, it will be helpful to describe the physical location of magnetometer 28 and its relationship to the body of the aircraft, which will be done with respect to FIGS. 3-5.

FIG. 3 depicts an aircraft 48 having a pair of wings 50, one of which includes magnetometer 28 mounted therein. Magnetometer 28 has been enlarged in FIGS. 3-5 for purposes of illustration, Magnetometer 28 is mounted in the right wing 50 of aircraft 48 at a location remote from a body 52 of aircraft 48, as well as from engines 54, thereby providing greater isolation of magnetometer 28 from the ferromagnetic materials of the body 52 of aircraft 48. While aircraft 48 illustrated in FIG. 3 is a commercial passenger jet, it will be understood that the method and system of the present invention is applicable to any and all types of aircraft having navigation sensors mounted in wings that flex during flight.

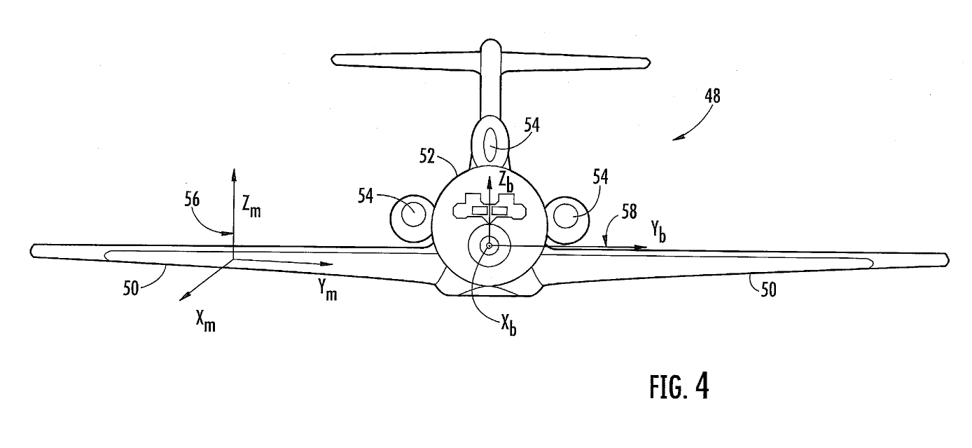

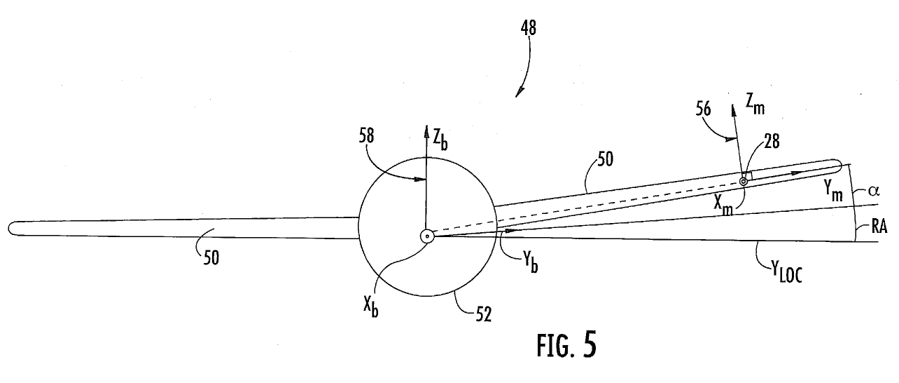

Magnetometer 28 defines a corresponding magnetometer frame of reference 56, as illustrated in FIGS. 3-5. Magnetometer frame of reference 56 is fixed with respect to magnetometer 28. The letters Xₘ, Yₘ, and Zₘ in FIGS. 3-5 identify the X, Y, and Z axes, respectively, of magnetometer frame of reference 56 where the subscript “m” refers to “magnetometer.” The Z axis of magnetometer frame of reference 56 is identified as a circle with a dot in it in FIG. 3 and extends vertically out of the page of FIG. 3 perpendicular to both Xₘ and Yₘ. In FIGS. 4 and 5, the Z axis of magnetometer frame of reference 56 is illustrated more clearly.

FIGS. 3-5 also depict an aircraft body frame of reference 58 which is fixed with respect to body 52 of aircraft 48. Body frame of reference 58 consists of three mutually perpendicular axes X_{b}, Y_{b}, and Z_{b}, where the subscript “b” refers to “body.” The Z_{b} axis, like the Zₘ axis, is illustrated in FIG. 3 as a circle with a dot in the middle, representing an axis that extends vertically out of the plane of FIG. 3 perpendicularly to both X_{b} and Y_{b}. The Z_{b} axis is illustrated more clearly in FIGS. 4 and 5, which depict the X_{b} axis as a circle with a dot in the middle representing an axis extending vertically out of the plane of FIGS. 4 and 5.

As can be seen from an examination of FIGS. 3 and 4, the X and Y axes of magnetometer frame of reference 56 and body frame of reference 58 are not parallel. While the Z axes of reference frames 56 and 58 are illustrated as being parallel in FIGS. 3 and 4, this need not be the case. FIG. 5 illustrates an aircraft configuration in which the Zₘ and Z_{b} axes are not parallel (as well as the Yₘ and Y_{b} axes). In general, one, two, or three of the axes of magnetometer frame of reference 56 may be rotated with respect to the axes of body frame of reference 58. In order for navigation system 20 to correctly use the outputs of magnetometer 28, navigation system 20 must first convert the magnetometer outputs from the magnetometer frame of reference 56 to the body frame of reference 58. As mentioned above, this is done by controller 30 at step 46.

Controller 30 carries out step 46 by utilizing the measured angular differences between the axes of the magnetometer frame of reference 56 and the body frame of reference 58. These measured differences are determined at the time magnetometer 28 is mounted in the wing 50 of aircraft 48. These measured differences can be described as consisting of three angles α, β, and θ, where α represents the roll angle of magnetometer frame of reference 56 with respect to body frame of reference 58 (i.e. the number of degrees magnetometer frame of reference 56 has rotated about the X axis of body frame of reference 58), β represents the pitch angle of magnetometer frame of reference 56 with respect to body frame of reference 58 (i.e. the number of degrees magnetometer frame of reference 56 has rotated about the Y axis of body frame of reference 58), and θ represents the yaw angle of magnetometer frame of reference 56 with respect to body frame of reference 58 (i.e. the number of degrees magnetometer frame of reference 56 has rotated about the Z axis of body frame of reference 58). In order to carry out the necessary rotations, it is convenient to represent the X, Y, and Z values of magnetometer 28 as a three-by-one matrix and use matrix multiplication. Specifically, the X, Y, and Z values of magnetometer 28 rotated into the body frame of reference can be found according to the following matrix equation:

$$[ \begin{matrix}{X}^{B} \\ {Y}^{B} \\ {Z}^{B}\end{matrix} ] = [ \begin{matrix}cos θ \cdot cos β & cos θ \cdot sin β \cdot sin α - sin θ \cdot cos α & cos θ \cdot sin β \cdot cos α + sin θ \cdot sin α \\ sin θ \cdot cos β & sin θ \cdot sin β \cdot sin α + cos θ \cdot cos α & sin θ \cdot sin β \cdot cos α - cos θ \cdot sin α \\ - sin β & cos β \cdot sin α & cos β \cdot cos α\end{matrix} ] * [ \begin{matrix}{X}^{M} \\ {Y}^{M} \\ {Z}^{M}\end{matrix} ] \qquad ( Eq . 1 )$$

where the symbol * denotes matrix multiplication, the quantities X^{M}, Y^{M}, and Z^{M} refer to the X, Y, and Z readings of magnetometer 28 in magnetometer frame of reference 56 (after they have been optionally scaled), and X^{B}, Y^{B}, and Z^{B} refer to those same measurements after they have been converted to body frame of reference 58. Controller 30 carries out this matrix multiplication at step 46, resulting in magnetometer readings that have been rotated into aircraft body frame of reference 58.

In the example illustrated in FIG. 5, magnetometer frame of reference 56 has been rotated by a roll angle of α about the X axis of the body frame of reference 58. Magnetometer frame of reference 56 has not been rotated about either the Y or Z axis of body frame of reference 58. Thus, in the wing and magnetometer configuration illustrated in FIG. 5, controller 30 would set β and θ both equal to zero, and would set α equal to the number of degrees of rotation illustrated in FIG. 5. Controller 30 would then carry out the matrix multiplication of Equation 1 using these values.

At step 60, controller 30 adjusts the magnetometer readings (in body frame of reference 58) to account for the effects that any hard and soft ferromagnetic materials of aircraft 48 may have upon the readings of magnetometer 28. This is done in a known and conventional manner and may involve an initial flight monitoring the output values of magnetometer 28 while the aircraft executes a 360 degree turn in order to determine the influence the hard and soft ferromagnetic materials of the aircraft may be having on magnetometer 28's readings. Once these influences are determined, controller 30 adjusts the values generated in step 46 to remove them.

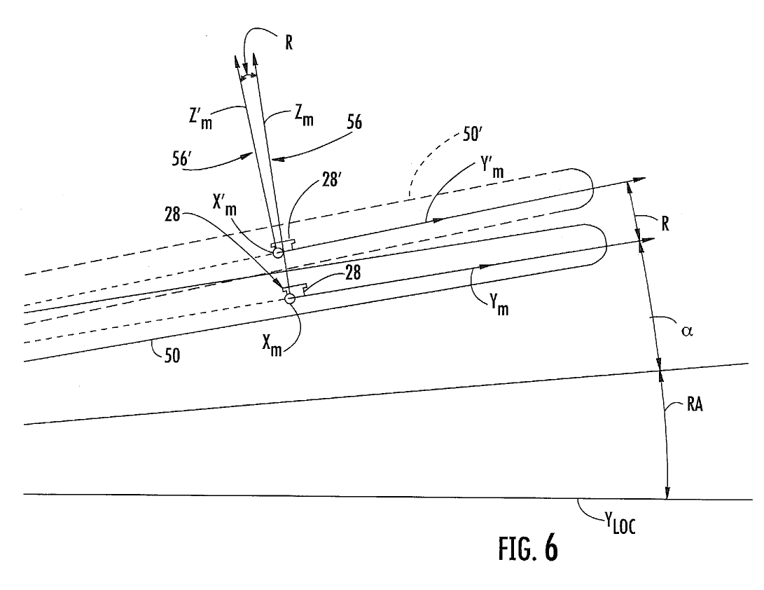

At step 62, controller 30 adjusts the readings from magnetometer 28 that have been scaled (optionally) in step 44, that have been rotated to body frame of reference 58 in step 46, and that have been corrected to remove the soft and hard ferromagnetic effects of the aircraft's materials in step 60. Controller 30 adjusts these readings by using a wing flex correction factor that accounts for the flexing of the aircraft's wings. In its most general form, the wing flex correction factor consists of three angles: a roll angle R, a pitch angle P, and a yaw angle Y. In practice, the yaw angle Y will most likely be zero and the pitch angle P may be negligible enough to consider to be zero, although the invention contemplates and can work in the situation where R, P, and Y are all non-zero. The most significant angle of the wing flex correction factor is the roll angle R. The roll angle R refers to the separate angular rotation of magnetometer 28 about the X axis of body frame of reference 58 due to the airborne flexing of wing 50 (illustrated in FIG. 6). In a corresponding manner, the pitch angle. P refers to the separate angular rotation of magnetometer 28 about the Y axis of body frame of reference 58 due to the airborne flexing of wing 50, and yaw angle Y refers to the separate angular rotation of magnetometer 28 about the Z axis of body frame of reference 58 due to the airborne flexing of wing 50. The reference to “separate angular rotation” refers to that rotation of magnetometer 28 which is caused solely by the airborne flexing of the wing. Stated alternatively, the angles R, P, and Y represent additional rotations over and above that represented by the angles α, β, and θ.

This can be understood more clearly with respect to FIG. 6, which depicts an example of a roll angle R. FIG. 6 is a close up view of the left wing 50 of the aircraft 48 depicted in FIG. 5 where wing 50′ (in phantom) illustrates the outline of the wing 50 after it has flexed. As can be seen, the flexing of wing 50′ causes magnetometer frame of reference 56 to change to a new position denoted by magnetometer frame of reference 56′, which is comprised of the axes Xₘ′, Yₘ′, and Zₘ′. Yₘ′ and Zₘ′ of frame of reference 56′ have been rotated counterclockwise with respect to Yₘ and Zₘ of frame of reference 56. They have specifically rotated in the roll direction above and beyond the angle a by an amount equal to angle R, causing magnetometer 28 to move to a new position denoted by reference identifier 28′. This creates a rotated magnetometer frame of reference 56′ which, if left uncorrected, would lead to errors in the calculation of heading.

Controller 30 compensates for these potential errors at step 62 by using a wing flex correction factor that accounts for the additional rotation R of magnetometer frame of reference 56′ with respect to body frame of reference 58. It will be noted that in the configuration illustrated in FIG. 6, rotated magnetometer frame of reference 56′ has been rotated, due to wing flexing, solely about the X axis of body frame of reference 58. Thus, the wing flex correction factor for the specific configuration illustrated in FIG. 6 would have Y and P angles equal to zero and an R value equal to the angular rotation illustrated in FIG. 6. In the general case, navigation system 20 is designed to account for wing flexing that rotates magnetometer frame of reference 56′ about all three axes of body frame of reference 58. Navigation system 20 accounts for this potential three-axis rotation in a manner similar to the manner in which controller 30 rotates magnetometer frame of reference 56 into alignment with body frame of reference 58. Specifically, at step 62, controller 30 treats the results from step 60 as a three-by-one matrix consisting of the values X^{SRC}, Y^{SRC}, and Z^{SRC}, where the superscript “SRC” refers to “scaled,” “rotated,” and “corrected.” In other words, X^{SRC}, Y^{SRC}, and Z^{SRC} are the values output by magnetometer 28 after they have been scaled in step 44 (optionally), rotated in step 46, and corrected in step 60. Controller 30 adjusts these values for any flexing of the wing by performing the following matrix multiplication:

$$[ \begin{matrix}{X}^{flex} \\ {Y}^{flex} \\ {Z}^{flex}\end{matrix} ] = [ \begin{matrix}cos Y \cdot cos P & cos Y \cdot sin P \cdot sin R - sin Y \cdot cos R & cos Y \cdot sin P \cdot cos R + sin Y \cdot sin R \\ sin Y \cdot cos P & sin Y \cdot sin P \cdot sin R + cos Y \cdot cos R & sin Y \cdot sin P \cdot cos R - cos Y \cdot sin R \\ - sin P & cos P \cdot sin R & cos P \cdot cos R\end{matrix} ] * [ \begin{matrix}{X}^{SRC} \\ {Y}^{SRC} \\ {Z}^{SRC}\end{matrix} ] \qquad ( Eq . 2 )$$

where the symbol * once again denotes matrix multiplication, the variables R, P, and Y refer to the roll angle R, pitch angle P, and the yaw angle Y of the wing flex correction factor discussed above, and the variables X^{flex}, Y^{flex}, and Z^{flex}, refer to the readings generated by controller 30 at step 62 after the flexing of wing 50 has been accounted for. It can be seen from this equation (Eq. 2) that if Y and P are equal to zero, as in the case illustrated in FIG. 5, then Equation 2 reduces to the following:

$$a . [ \begin{matrix}{X}^{flex} \\ {Y}^{flex} \\ {Z}^{flex}\end{matrix} ] = [ \begin{matrix}1 & 0 & 0 \\ 0 & cos R & - sin R \\ 0 & sin R & cos R\end{matrix} ] * [ \begin{matrix}{X}^{SRC} \\ {Y}^{SRC} \\ {Z}^{SRC }\end{matrix} ] \qquad ( Eq . 3 )$$

From reduced Equation 3 it can also be more clearly seen that the value X^{SRC} is unaffected when the wing flexes solely with a roll component (i.e. P and Y both equal zero). This accords with the example illustrated in FIG. 5 where the X axis of magnetometer frame of reference 56 (coming vertically out of the page) is parallel to the X axis of rotated magnetometer frame of reference 56′ (which also comes vertically out of the page). As a further mathematical check on Equation 2 used above by controller 30 in step 62, it can be seen that if all of the R, P, and Y values are equal to zero, the middle matrix reduces to the identity matrix and the values X^{flex}, Y^{flex}, and Z^{flex} will be equal to the values X^{SRC}, Y^{SRC}, and Z^{SRC}, respectively.

As illustrated in FIG. 2, navigation system 20 provides controller 30 with a choice of different wing flex correction factors to use in step 62. The differences between these wing flex correction factors, the manner in which one of them is chosen, and the manner in which they are generated will be discussed in more detail below after a discussion of steps 64 and 66.

At step 64, controller 30 utilizes the roll and pitch information from inertial attitude system 24 to rotate the values output from step 62 into a local level frame of reference. The local level frame of reference refers to a frame of reference that is aligned with body frame of reference 58 only when the aircraft is perfectly level. When the aircraft is not on level ground, or not in level flight, the body frame of reference 58 will not be aligned with the local level frame of reference, but will differ from it by a pitch angle and a roll angle. In FIGS. 5 and 6, the Y axis of the local level frame of reference is identified by the reference letter Y_{loc}. In those two figures, the Z axis of the local level frame of reference extends vertically upward from the Y_{loc} axis at a right angle, and the X axis of the local level frame of reference extends vertically out of the page perpendicularly to the plane of the page. The pitch and roll angle with respect to the local level frame of reference will be detected by inertial attitude system 24 and used by controller 30 to perform the appropriate rotation into a local level frame at step 64.

The rotation to a local level frame of reference at step 64 is necessary to process the X, Y, and Z outputs from the magnetometer into a determination of geographic heading, which is done at step 66 and carried out in a known and conventional manner. In FIGS. 4 and 5, inertial attitude system 24 would detect a roll angle RA that controller 30 would use to convert the magnetometer outputs to a local level frame of reference. Inertial attitude system 24 would detect no pitch angle in the situation illustrated in FIGS. 4 and 5 because the X_{b} axis of body frame of reference 58 in FIGS. 4 and 5 extends vertically out of the page perpendicular to the plane of the page. After controller 30 computes heading 40 in step 66, the heading information may be fed back into inertial attitude system 24 to provide a long term heading reference for stabilizing the sensors within inertial attitude system 24.

The manner in which controller 30 selects a wing flex correction factor for use in step 62 will now be described. In FIG. 1, controller 30 is illustrated as receiving data from airborne sensor 26. Airborne sensor 26 is used in the process of selecting which wing flex correction factor to use in step 62. Airborne sensor 26 may be any type of sensor that indicates whether aircraft 48 is airborne or on the ground. In one embodiment, airborne sensor 26 is a “weight on wheels” sensor that senses the weight of the aircraft on the wheels. When the aircraft is on the ground, the “weight on wheels” sensor senses the weight of the aircraft and outputs a signal through interface 36 to controller 30 indicating the aircraft is grounded. When the aircraft is in the air, there is no more weight on the wheels, and the “weight on wheels” sensor sends a signal through interface 36 to controller 30 indicating the aircraft is airborne.

Controller 30 uses the information from airborne sensor 26 to decide what wing flex correction factor to use. When aircraft 48 is on the ground, there is no need to correct the outputs of magnetometer 28 for flexing of the wings because the wings are in their nominal orientation relative to the fuselage, which was measured at the time magnetometer 28 was installed and is known. Consequently, if airborne sensor 26 indicates the aircraft is grounded, controller 30 uses a wing flex correction factor at step 62 in which all three values, R, P, and Y are equal to zero (or, equivalently, by using no wing flex correction factor at all). If airborne sensor 26 indicates the aircraft is in the air, controller 30 uses a full wing flex correction factor (i.e. R, P, and Y). Controller 30 thus chooses between two different methods for processing the navigation signal from magnetometer 28: a first method in which a wing flex correction factor consisting of all zeros is used (or, equivalently, no wing flex correction factor at all), and a second method in which at least one of the wing flex correction factor terms in non-zero. The process for determining the individual R, P, and Y values is described in more detail later.

In an alternative embodiment of navigation system 20, airborne sensor 26 could be an airspeed detector. Because airspeed is not an exact indication of whether an aircraft is airborne or not, due primarily to the different loads an aircraft may be carrying, navigation system 20 operates in a different manner when using an airspeed sensor than when it uses a wheel weight sensor. The operation of navigation system 20 when an airspeed sensor is used is described in block diagram form in FIG. 2. Unlike the situation where a wheel weight sensor is used and controller 30 selects from one of two wing flex correction factors—a correction factor of all zeros or a full correction factor—controller 30 selects from one of three wing flex correction factors when airborne sensor 26 comprises an airspeed sensor.

When using an airspeed sensor, controller 30 determines the airspeed of the aircraft at step 68 (FIG. 2). At step 70, controller 30 compares the airspeed to a lower threshold. If the airspeed is less than the lower threshold, controller 30 uses a wing flex correction factor of all zeros (R=0, P=0, and Y=0). If the airspeed is not less than the lower threshold, controller 30 determines at step 72 whether the airspeed is equal to or between the lower threshold and an upper threshold. If the airspeed is equal to or between these two thresholds, controller 30 uses a reduced wing flex correction factor at step 62. If the airspeed is not equal to or between the lower and upper thresholds, then it must be greater than the upper threshold, in which case controller 30 uses the full wing flex correction factor.

When controller 30 determines it should use a reduced wing flex correction factor (i.e. when it determines that the airspeed is equal to or between the upper and lower thresholds), it calculates the reduced wing flex correction factor by multiplying the full wing flex correction factor by a fraction F determined according to the following formula:

$$1. F = \frac{Airspeed - LowerThreshold}{UpperThreshold - LowerThreshold} \qquad ( Eq . 4 )$$

Thus, if an aircraft has an airspeed of 65 knots, the upper threshold is equal to 70 knots and the lower threshold is equal to 50 knots, F will be equal to [(65−50)/(70−50)], which is equal to 15/20, or 0.75. In such a case, if the full wing flex correction factor has R=3 degrees, P=0.5 degrees, and Y=0 degrees, then the reduced wing flex correction factor will have R=(0.75)(3), or 2.25 degrees; P=(0.75)(0.5), or 0.375 degrees; and Y=(0.75)(0), or 0 degrees. If the airspeed picks up to 70 knots in this case, the fraction F becomes 1 and the full wing flex correction factor of R=3, P=0.5, and Y=0 is used. Above 70 knots the full wing flex correction factor is also used.

There is a relatively wide degree of latitude for choosing the specific values for the upper and lower thresholds. Further, the choice of upper and lower thresholds will generally vary with different airframes. In general, the lower threshold is preferably near the minimum takeoff airspeed for a given airframe, and the upper threshold is preferably near the airspeed necessary to send the airframe aloft when it is carrying its maximum rated load. By choosing upper and lower thresholds in this manner, the airspeed can be used as an acceptably accurate indicator of whether an aircraft is aloft or on the ground. An aircraft with an airspeed less than the lower threshold should be on the ground since it has an airspeed less than the minimum required for sustaining flight. Likewise, an aircraft having an airspeed greater than the upper threshold should be in the air since it has an airspeed that would normally, provided it is not overloaded or absent some other exceptional circumstance, cause it to take off. For airspeeds between the upper and lower thresholds, the aircraft may or may not be on the ground, and navigation system 20 addresses this situation by using a reduced wing flex correction factor.

It should be noted that, in the situation where controller 30 determines at step 70 that the airspeed is less than the lower threshold and selects a wing flex correction factor of all zeros, it is not necessary for controller 30 to actually perform the matrix multiplication described above at step 62 (Eq. 2). This is because, as also noted above, the matrix which the X^{SRC}, Y^{SRC}, and Z^{SRC} are multiplied by reduces to an identity matrix when R, P, and Y are all zero. Thus, in that situation, controller 30 can save processing time by simply skipping step 62 and rotating at step 64 the outputs from step 60.

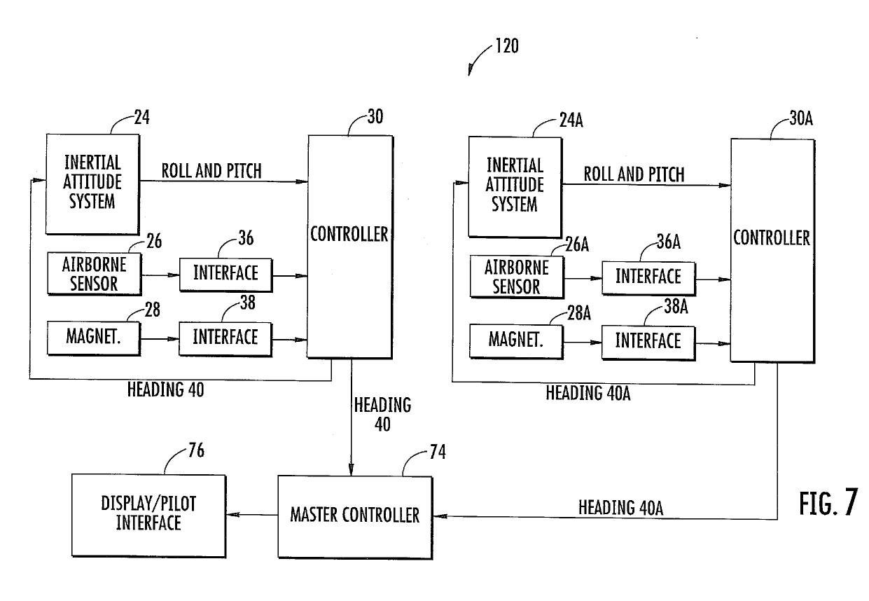

While the discussion to this point has focused on only a single magnetometer, navigation system 20 can be modified to include two or more magnetometers. An example of a navigation system 120 having two magnetometers 28 and 28A is illustrated in FIG. 7. Navigation system 120 also includes two inertial attitude systems 24 and 24A, two airborne sensors 26 and 26A, two controllers 30 and 30A, and two sets of interfaces 36-38 and 36A-38A. Controller 30 outputs heading 40 in the manner described above using the information from inertial attitude system 24 and sensors 26 and 28. Controller 30A outputs a second heading 40A using the information from inertial attitude system 24A and sensors 26A and 28A. Controller 30A calculates second heading 40A in the same mainer as controller 30 calculates first heading 40. In other words, controller 30A follows steps 44, 46, 60, 62, and 64 to calculate second heading 40A, and if airborne sensor 26A is an airspeed sensor, controller 30A will also follow steps 68, 70, and 72 to determine which wing flex correction factor to use at step 62. The only difference in the methods in which controller 30 and 30A calculate heading is that controller 30A may use different values for α, β, and θ in step 46, and a different wing flex correction factor in step 62 than that used by controller 30. The different values controller 30A may use in steps 46 and 62 both depend upon where second magnetometer 28A is positioned in the aircraft.

If magnetometer 28A is mounted in the same wing as magnetometer 28, then controller 30A will use the same values for magnetometer 28A's wing flex correction factor as it does for magnetometer 28's wing flex correction factor (assuming the magnetometers are mounted sufficiently close together such that the degree of wing flex does not vary appreciably between the two locations). If magnetometer 28A is mounted in a wing opposite to magnetometer 28 and in a generally symmetrical manner, then controller 30A will use the same pitch value P for magnetometer 28As' wing flex correction factor as controller 30 does for magnetometer 28's wing flex correction factor, but controller 30A will use roll R and yaw Y values having the same magnitude but opposite signs to the R and Y values used by controller 30 for magnetometer 28's wing flex correction factor. The opposite signs are due to the fact that the right and left wings will roll about the X axis of body frame of reference 58 in opposite directions, and will yaw about the Z axis (if any yaw flexing should occur) of body frame of reference 58 in opposite directions. If magnetometers 28 and 28A are mounted in opposite wings but not symmetrically, or in the same wing but in locations where they experience a different amount or kind of flexing, then the wing flex correction factors used by controllers 30 and 30A for the two respective magnetometers will likely have one or more R, P, or Y values that differ in magnitude as well as sign. Any differences in the α, β, and θ values used by controllers 30 and 30A will be determined at the time the magnetometers 28 and 28A are installed in the aircraft.

One of the advantages of the two magnetometers 28 and 28A in navigation system 120 is that two, independent calculations of heading are computed. Should inertial attitude system 24 or sensors 26 or 28 (or interfaces 36-38) connected to controller 30 fail, or should controller 30 itself fail, navigation system 120 will still generate a measurement of heading 40A via controller 30A and its respective inertial attitude system 24A and sensors 26A and 28A. Alternatively, should any of the components responsible for generating heading 40A fail, controller 30 will still generate heading 40. Navigation system 120 thus provides redundant measurements of heading that enable it to continue to give heading information to the pilot even if one of its components should fail.

As illustrated in FIG. 7, the headings 40 and 40A output by controllers 30 and 30A, respectively, are fed into a master controller 74. Master controller 74 repeatedly compares the first and second headings 40 and 40A. If the two headings differ by more than a chosen tolerance for a given amount of time, master controller 74 sends a warning signal to a display or pilot interface device 76 indicating to the pilot that the two magnetometers are not reporting the same heading. The pilot can then take appropriate action, including instructing navigation system 120 to switch which heading (first heading 40 or second heading 40A) it is displaying on interface device 76 to the pilot. Master controller 74 may comprise one or more microprocessors with associated memory, or any other combination of appropriate electronic circuitry capable of carrying out the functions described herein, as would be understood by one skilled in the art. Display/pilot interface 76 may be an LCD screen with push buttons, or any other type of device capable of communicating information to the pilot and receiving commands back from the pilot.

As is also illustrated in FIG. 7, controllers 30 and 30A also preferably feed their determinations of heading into inertial attitude systems 24 and 24A, respectively. The headings 40 and 40A computed by controllers 30 and 30A provide a long term yaw (heading) reference for stabilizing the sensors within inertial navigation systems 24 and 24A.

Having described above how controller 30 (or controller 30A) determines which wing flex correction factor to use, it is appropriate to describe the manner in which the values for the full wing flex correction factor are determined for navigation systems 20 and 120. In general, the values R, P, and Y are determined by measurement. This is accomplished most directly by flying an aircraft and physically measuring the amount of wing flex that occurs during flight in the roll, pitch, and yaw directions. Because the amount of wing flex will vary to a certain extent with different loads, and during turns or other maneuvers of the airplane, it is preferable to choose the measured R, P, and Y values that are recorded during level flight and while the aircraft is carrying a load that is representative for that particular airframe. The values R, P, and Y need not be measured for every single aircraft using navigation system 20, but instead can be measured once for a particular airframe and then assumed to be accurate for all subsequent flights and for all airplanes having the same airframe. These values can then be used by navigation system 20 for any model of aircraft that uses the same airframe.

In practice, the yaw value Y can be set to zero since it is unlikely that an airplane wing will flex in a rotational manner about the Z axis of body frame of reference 58. Pitch value P will generally be negligible and can either be measured or set to zero. Roll value R is generally the most significant of the three values and therefore the most important one to measure. All three values can be measured in any suitable manner. One such manner is to temporarily mount a level sensor in the wing and measure the actual amount of flexing in the roll, pitch, and yaw directions. These measurements are then stored and the temporary level sensor can be removed. The stored measurements can then be used on the aircraft on which the measurements were taken, as well as any other aircraft using the same airframe.

Another way for measuring the roll value R consists of installing magnetometer 28 in one wing 50 and magnetometer 28A in the opposite wing in a symmetrical manner to magnetometer 28 and then calculating the roll value R according to the following formula:

$$R = arctan [ sin ( Heading Error ) \cdot \frac{Horizontal Field Strength}{Vertical Field Strength} ] \qquad ( Eq . 5 )$$

The “Horizontal Field Strength” refers to the strength of the horizontal component of the Earth's magnetic field as measured by magnetometer 28 and/or 28A. The “Vertical Field Strength” refers to the strength of the vertical component of the Earth's magnetic field as measured by magnetometer 28 and/or 28A. The “Heading Error” refers to the average difference in headings generated from magnetometer 28 and 28A when the aircraft is heading due north and then due south. More specifically, the “Heading Error” is calculated according to the following formula:

$$Heading Error = \frac{1}{4} \cdot [ \begin{matrix}\vert {Head}_{Mag 28 North} - {Head}_{Mag 28 A North} \vert + \\ \vert {Head}_{Mag 28 South} - {Head}_{Mag 28 A South} \vert\end{matrix} ] \qquad ( Eq . 6 )$$

In this formula (Eq. 6), the term “Head_{Mag28 North}” refers to the heading generated from the output of magnetometer 28 while the plane is flying due north. The term “Head_{Mag28A North}” refers to the heading generated from the output of magnetometer 28A while the plane is flying due north. The term “Head_{Mag28 south}” refers to the heading generated from the output of magnetometer 28 when the plane is flying due south. The term “Head_{Mag28A South}” refers to the heading generated from the output of magnetometer 28A when the plane is flying due south. Thus, the “Heading Error” is calculated by computing the absolute value of the difference between the headings generated from magnetometers 28 and 28A while the plane is flying due north, summing that difference with the absolute value of the difference between the headings generated from magnetometers 28 and 28A while the plane is flying due south, and then multiplying the total sum by one fourth. The result yields a value for the “Heading Error” term that is then plugged into Equation 5 for calculating the roll angle R. Because roll wing flexing causes the wings to rotate in opposite directions, the R value calculated from Equation 6 will be used in the wing flex correction factor for only one wing. An R value of equal magnitude but opposite sign will be used in the wing flex correction factor for magnetometers mounted in the opposite wing.

The roll angle R can also be calculated by simplifying Equation 5. When the roll angle R is less than five degrees, R can be acceptably approximated according to the following equation:

$$R = Heading Error \cdot \frac{Horizontal Field Strength}{Vertical Field Strength} \qquad ( Eq . 7 )$$

where the term “Heading Error” is calculated in accordance with Equation 6 above, and the terms “Horizontal Field Strength” and “Vertical Field Strength” refer to the horizontal and vertical components, respectively, of the Earth's magnetic field. Equation 7, as noted, is only an approximate calculation of R, but it is typically acceptably close when R is less than about five degrees.

Consider, for example, the situation where the Heading Error of Equation 6 is determined to be four degrees and the magnetometer readings indicate the horizontal component of the Earth's magnetic field is 0.180 gauss and the vertical component is 0.540 gauss. Plugging these numbers into Equation 5 yields a roll angle R of 1.332 degrees. Plugging these numbers into Equation 7 yields a roll angle R of 1.333 degrees. The difference between the two R values is negligible.

Navigation system 120 can be further modified in several ways to account for any residual wing flex errors. Residual wing flex errors refer to the errors between the wing flex correction factor and the actual amount of flexing (from the nominal position) the aircraft wing undergoes while in flight. Stated alternatively, the residual wing flex errors are errors caused by wing flex that remains after the wing flex correction factor has been applied. Because the wing flex correction factor need only be determined once for a given aircraft with a given load under a given set of conditions, it is likely that there will be small residual wing flex errors because the R, P, and Y values will not precisely match the change in roll, pitch, and yaw angles caused by the flexing of the wing. While these residual wing flex errors should be small enough to ignore in the general case, the present invention contemplates taking further steps to reduce these errors.

In one embodiment, navigation system 120 reduces any residual wing flex error by averaging the results of step 64 for magnetometer 28 and magnetometer 28A where magnetometers 28 and 28A are symmetrically positioned in opposite wings. Stated alternatively, controller 30 processes the output of magnetometer 28 by completing all of the steps in FIG. 2 through step 64 and passes the results of step 64 to master controller 74. These results consist of the X, Y, and Z values from magnetometer 28 after they have been scaled, corrected, and rotated (potentially three times in steps 46, 62, and 64). Controller 30A does the same thing as controller 30. That is, controller 30 processes the output of magnetometer 28A by completing all of the steps in FIG. 2 through step 64 and passes the results of step 64 to master controller 74. Master controller 74 thus receives the scaled, corrected, and rotated X, Y, and Z values from magnetometers 28 and 28A. Master controller 74 averages the Y value from magnetometer 28 with the Y value from magnetometer 28A and then uses this averaged Y value with either the X and Z values from magnetometer 28 or the X and Z values from magnetometer 28A to compute a single heading.

This single computation of heading will reduce the residual errors caused by the roll angle R of the wing flex correction factor not precisely equaling the actual amount of flexing of the wings in the roll direction (i.e. about body reference 58's X axis). This reduction of roll residual errors occurs because the wings flex in opposite directions about the X axis of the body frame of reference 58, and any residual errors in the roll angle R (which show up in the Y values of the magnetometers) will cancel each other out. This teclmique of averaging the Y outputs from controllers 30 and 30A prior to calculating a heading, however, results in only a single heading calculation and destroys the independence of the information from the two magnetometers 28 and 28A. Thus, this method of reducing residual wing flex errors only works if both magnetometers 28 and 28A and their associated hardware are operating correctly.

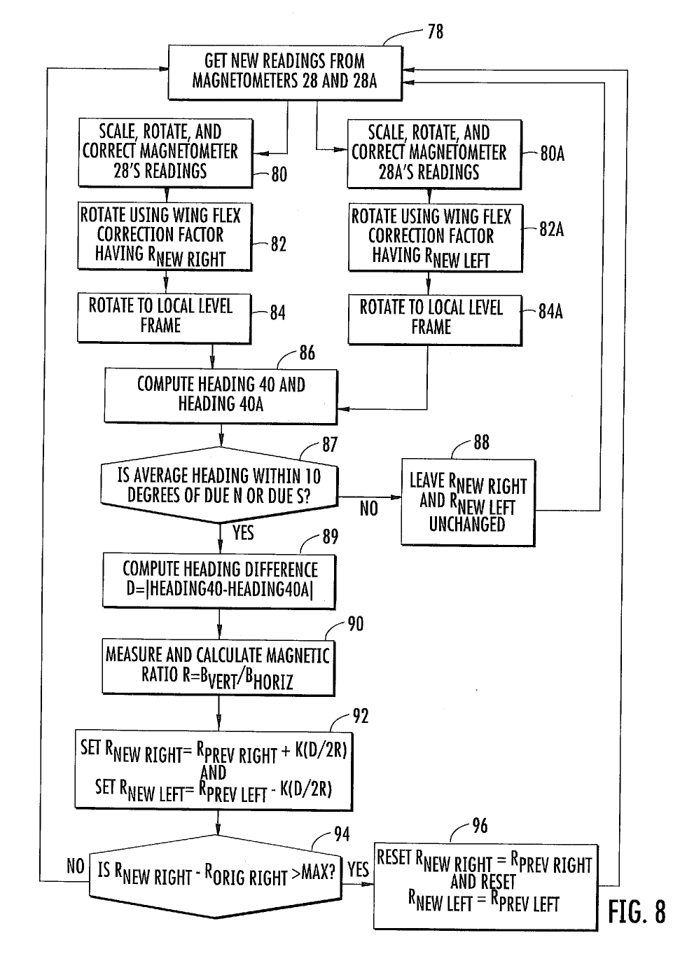

Another method for reducing or eliminating residual wing flex errors caused by the roll angle R not precisely matching the actual amount of wing flex in the roll direction is illustrated in block diagram format in FIG. 8. This method, unlike the method described in the preceding paragraph, preserves the independence of the two magnetometer readings. In general, this method makes minor adjustments, as necessary, to the roll angle R while the aircraft is heading within ten degrees of either due north or due south. When the aircraft is not flying within ten degrees of due north or due south, the roll angle R does not change. In order to more clearly describe the adjustments that are made when the aircraft is within ten degrees of due north or due south, the reference letters R_{orig right} and R_{orig left} will be used to refer to the original R values of the wing flex correction factor for the right and left wings, respectively, prior to them being changed in the manner to be described with reference to FIG. 8. Thus R_{orig right} is merely a different notation identifying the same R value that was discussed above and used to adjust the outputs of magnetometer 28 mounted in the right wing. Similarly, R_{orig left} is merely a different notation identifying the same R value that was discussed above and used to adjust the outputs of magnetometer 28A when mounted in the left wing. The subscript “orig” has been added to uniquely identify these values as they change in accordance with the residual error reduction method of FIG. 8.

The steps for reducing the residual wing flex roll errors of FIG. 8 are preferably carried out only while the airplane is aloft. If the navigation system implementing the steps of FIG. 8 uses an airspeed sensor for airborne 26, then the steps of FIG. 8 are preferably only carried out when the airspeed exceeds the upper threshold discussed above with respect to FIG. 2. At step 78, new magnetometer readings are obtained from magnetometers 28 and 28A. At step 80, controller 30 scales, rotates, and corrects magnetometer 28's readings in the same manner as that described previously in steps 44, 46, and 60. Similarly, at step 80A, controller 30A performs the scaling, rotating, and correcting of steps 44, 46, and 60 upon magnetometer 28A's output. At steps 82 and 82A, controllers 30 and 30A, respectively, rotate the values output from steps 80 and 80A by their respective wing flex correction factors. As can be seen in FIG. 8, the wing flex correction factor that controller 30 uses at step 82 has a roll value identified as R_{new right}, and the wing flex correction factor that controller 30A uses at step 82A has a roll value identified as R_{new left}. The first time controllers 30 and 30A run through the sequence of steps illustrated in FIG. 8.

R_{new right} is equal to R_{orig right}, and R_{new left} is equal to R_{orig left}. As will be seen, the values R_{orig right} and R_{orig left} will never change throughout the sequence of steps of FIG. 8. The values R_{new right} and R_{new left}, however, may change.

At steps 84 and 84A, controllers 30 and 30A respectively rotate the values output at steps 82 and 82A into a local level frame of reference. Controllers 30 and 30A rely on the measurements of roll and pitch provided by inertial attitude systems 24 and 24A to effect this rotation. The manner in which the rotations are carried out is the same as that described above with respect to step 64 in navigation system 20. At step 86, either controllers 30 and 30A, or master controller 74 computes headings 40 and 40A. At step 87, master controller 74 averages the two headings (40 and 40A) together and determines from the average heading whether the aircraft is heading within ten degrees of either due north or due south. If it is not, master controller 74 makes no change to the R_{new right} and R_{new left} values at step 88. After step 88, master controller 74 returns to step 78 and the cycle of steps 78-87 repeats itself. This cycle will continue to repeat itself as long as the aircraft continues flying at a heading more than ten degrees away from due north or due south.

At any point during the flight, if master controller 74 determines at step 87 that the aircraft is heading in a direction within ten degrees of due north or due south, master controller jumps to step 89, where it calculates the absolute value of the difference between the two heading calculations done at step 86. This difference is identified in FIG. 8 by the letter D. At step 90, master controller 74 computes a ratio R defined as the ratio of the vertical component of the Earth's magnetic flux density (Bᵥₑᵣₜ) to the horizontal component of the Earth's magnetic flux density (B_{horiz}) This ratio is computed using the data supplied by either magnetometer 28 or magnetometer 28A (or both and averaged together).

At step 92, master controller 74 computes a R_{new right} and a R_{new left} value for use in the wing flex correction factor. R_{new right} is set equal to the previous value of R for the right wing (R_{prev right}) summed together with the quantity K(D/2R). R_{new left} is set equal to the previous value of R for the left wing (R_{prev left}) minus the quantity K(D/2R). The quantity R_{prev right} refers to the value of R_{new right} that was generated during the immediately prior iteration of the steps of FIG. 8 (regardless of whether the iteration was a shortened iteration of just steps 78-88, or a complete iteration that included steps 78 through 94 or 96). Similarly, the quantity R_{prev left} refers to the value of R_{new left} that was generated during the immediately prior iteration of the steps of FIG. 8. Thus, the previous values refer to what was calculated as new values during the preceding iteration. In the case where the steps of FIG. 8 are being performed for the first time, R_{prev right} iS equal to R_{orig right}, and R_{prev left} is equal to R_{orig left}. The quantity K(D/2R) is computed by multiplying a filtering factor K times the quantity D computed in step 89 and dividing the result by twice the ratio R computed in step 90. The filtering factor may be 1, in which case no filtering takes place, or it may be set to other values less than 1 so that the adjustments to the right and left R values are carried out gradually and smoothly, and not abruptly. K, for example, could be set equal to the inverse of the sampling rate (i.e. the reciprocal of the rate at which new readings are gathered from magnetometers 28 and 28A, which may, for example, be twenty times a second) divided by a selected time constant, such as sixty seconds. In such a case, K would be equal to 1/1200th, ( 1/20th divided by 60) and it would take one full time constant for the right and left R value adjustments to be approximately 63% implemented (provided D and R didn't change).

At step 94, master controller 74 compares the newly computed right R value (R_{new right}) to the original right R value (R_{orig right}). If the difference between these two values exceeds a maximum (Max), master controller 74 moves onto step 96. At step 96, master controller 74 resets the values of R_{new right} and R_{new left} that were calculated in step 92 back to R_{prev right} and R_{prev left}, respectively. This has the effect of limiting the amount of adjustments that can be made to the original R values (R_{orig left} and R_{orig right}) to a total that doesn't exceed the maximum value (Max). Thus, the steps for reducing or eliminating residual roll etrors illustrated in FIG. 8 are limited to adjustments in the original R values that don't exceed the predetermined maximum (Max), which may, for example, be set to 1 degree. After master controller 74 completes the operations of step 96, control returns to step 78 where further magnetometer readings are taken and the steps of FIG. 8 are repeated.

Returning to step 94, if the difference between R_{new right} and R_{orig right} is less than the predetermined maximum value (Max), then master controller 74 skips step 96 and returns back to step 78 where the process illustrated in FIG. 8 repeats. On the second iteration through the steps of FIG. 8, R_{new right} and R_{new left} will be different from R_{orig right} and R_{orig left} (assuming D was not equal to zero and step 96 was skipped). On this second iteration, R_{prev right} and R_{prev left} will be equal to R_{new right} and R_{new left} from the preceding (i.e. first) iteration, respectively. After a flight is completed and the airplane lands, all the R values are reset to R_{orig right} and R_{orig left}, accordingly.

The method for dynamically changing the R values illustrated in FIG. 8 can be modified so that changes to the R value can be implemented regardless of whether the aircraft is flying within ten degrees of due north or due south. Such a modification involves deleting steps 87, 88, and 90-96 from the flowchart of FIG. 8 and characterizing the heading split D (determined at step 89) relative to the average heading (40 and 40A averaged together) over a full 360 degrees of heading change. Residual wing flex roll errors over 360 degrees of heading, when plotted, will map out a single cycle of the sine function over 360 degrees and will peak at 0 and 180 degrees. By keeping a historical log of the heading splits measured in step 89 as a function of average heading, statistical analysis of the log can be performed to detect components which match the characterized heading splits. These components can then be analyzed and used to adjust the R values to lessen residual errors. This analysis and adjustment would take place in lieu of steps 90-96 in FIG. 8.

Navigation systems 20 and 120 can be further modified in instances where they are used on airframes where wing flex varies appreciably with loading. In such situations, the amount of wing flex can be characterized and dynamically adjusted. For instance, in normal unaccelerated flight, the wings support 1G. However, for coordinated flight in a 45 or 60 degree bank, the wings will see loading increase by 41% and 100%, respectively. In such cases, the wing flex roll compensation angle R can be made a function of bank angle. Controllers 30 and 30A accomplish this by reading the outputs of on-board sensors indicating how many degrees the airplane is banking and adjusting the R value accordingly.

It should be noted again that the steps for adjusting the R values of the wing flex correction factor during flight that are illustrated in FIG. 8 are optional. Navigation system 20 and 120 are fully functional without modifying the wing flex correction factor values. Stated alternatively, navigation system 20 and 120 are completely functional where controller 30 selects a wing flex correction factor of zero, a full wing flex correction factor, or a partial wing flex correction factor, as described above in step 62, and there are no modifications to the wing flex correction factor. However, navigation systems 20 and 120 can be modified to include dynamic wing flex correction factors in accordance with the steps described in FIG. 8.

While the present invention has been described primarily with respect to correcting magnetometer readings due to wing flexing, it will be understood that navigation system 20 finds equal application to any navigation sensors that can be mounted in the wings of an aircraft and whose outputs change with flexing of the wing. Thus, navigation system 20 and its associated methods need not be limited to correcting wing flex induced magnetometer errors, but can be used to correct any wing flex induced navigation errors.

Further, it will be understood by one skilled in the art that, although the present invention has been described in terms of the preferred embodiments depicted in the drawings and discussed in the above specification, along with several alternative embodiments, the present invention is not limited to these particular embodiments, but includes any and all such modifications that are within the spirit and the scope of the present invention as defined in the appended claims.

What is claimed is:

1. A navigational reference system for an aircraft having at least one wing, said system comprising:
a navigation sensor secured to said at least one wing, said navigation sensor adapted to output a signal;
an airborne sensor adapted to provide information indicating when the aircraft becomes airborne; and
a controller adapted to use said signal to compute navigation information of the aircraft, said controller computing the navigation information of the aircraft using a first method when said airborne sensor indicates said aircraft is on the ground, and said controller computing the navigation information of said aircraft using a second method when said airborne sensor indicates said aircraft is airborne, said first method being different from said second method.

2. The system of claim 1 wherein said navigation sensor is a magnetometer adapted to sense the Earth's magnetic field, and said navigation information of the aircraft is a heading of the aircraft.

3. The system of claim 2 where said second method includes adjusting the signal from said magnetometer by a wing flex correction factor in order to compensate for flexing of said at least one wing.

4. The system of claim 3 wherein said wing flex correction factor includes both a non-zero pitch component and a non-zero roll component.

5. The system of claim 3 wherein said first method includes leaving the signal from said magnetometer unadjusted by the wing flex correction factor.

6. The system of claim 3 wherein said wing flex correction factor is based upon an assumed amount of flexing of said at least one wing.

7. The system of claim 1 wherein said airborne sensor is an airspeed sensor and said controller determines said aircraft to be airborne when said airspeed sensor detects an airspeed equaling or exceeding a first threshold.

8. The system of claim 7 wherein said second method includes adjusting the signal from said navigation sensor by a wing flex correction factor in order to compensate for flexing of said at least one wing, said wing flex correction factor varying in relation to varying airspeeds detected by said airspeed sensor.

9. The system of claim 8 wherein said wing flex correction factor varies in relation to airspeeds detected by said airspeed when said airspeed is equal to or above said first threshold and equal to or below a second threshold, said second threshold being higher than said first threshold.

10. The system of claim 9 wherein said wing flex correction factor remains constant when the airspeed detected by said airspeed sensor exceeds said second threshold.

11. The system of claim 10 wherein said navigation sensor is a magnetometer adapted to sense the Earth's magnetic field, and said navigation information of the aircraft is a heading of the aircraft.

12. The system of claim 2 further including a second magnetometer adapted to output a second signal relating to the Earth's magnetic field wherein said controller is adapted to compute a second heading of said aircraft based on said second signal of said second magnetometer, said controller computing said second heading of the aircraft using said second magnetometer and said first method when said airborne sensor indicates the aircraft is on the ground, and said controller computing said second heading of the aircraft using said second magnetometer and said second method when said airborne sensor indicates the aircraft is airborne.

13. The system of claim 12 wherein said second magnetometer is located in a second wing of said aircraft different from said at least one wing.

14. The system of claim 13 wherein said second method includes adjusting the signal from said magnetometer by a wing flex correction factor in order to compensate for flexing of said at least one wing, and adjusting the second signal from said second magnetometer by a second wing flex correction factor in order to compensate for flexing of said second wing.

15. The system of claim 14 wherein said controller determines a difference between said heading and said second heading and, if said difference is non-zero, changes said first and said second wing flex correction factors, and if said difference is zero, leaves said first and said second wing flex correction factors unchanged.

16. The system of claim 15 wherein said controller changes said first and said second wing flex correction factors by an amount no greater than a predetermined maximum.

17. The system of claim 2 further including a second magnetometer mounted in a second wing of the aircraft different from said at least one wing and adapted to output a second signal relating to the Earth's magnetic field wherein said controller is adapted to compute the heading of the aircraft by averaging said signal and said second signal together prior to computing the heading.

18. The system of claim 17 where said second method includes adjusting the signal from said magnetometer by a wing flex correction factor in order to compensate for flexing of said at least one wing, and adjusting the second signal from said second magnetometer by a second wing flex correction factor in order to compensate for flexing of said second wing.

19. A method of determining navigation information for an aircraft having a body and at least one wing attached to said body, said method comprising:
providing a navigation sensor mounted in the at least one wing of the aircraft, said navigation sensor adapted to output a navigation signal;
defining a navigation sensor frame of reference fixed with respect to said navigation sensor,
defining a body frame of reference fixed with respect to said body of said aircraft; and
transforming said navigation signal from the navigation sensor frame of reference to the body frame of reference using a wing flex correction factor, said wing flex correction factor accounting for flexing of said at least one wing with respect to said body, said wing flex correction factor being determined prior to said aircraft becoming airborne.

20. The method of claim 19 wherein said navigation sensor is a magnetometer adapted to sense the Earth's magnetic field, said navigation signal is a measurement of the Earth's magnetic field, and the navigation information for the aircraft is a heading.

21. The method of claim 20 wherein said wing flex correction factor includes both a non-zero pitch component and a non-zero roll component.

22. The method of claim 20 further including determining an airspeed of said aircraft and adjusting said wing flex correction factor based upon the determined airspeed.

23. The method of claim 22 wherein said adjusting of said wing flex correction factor based upon the determined airspeed includes reducing said wing flex correction factor when the determined airspeed is at or between a lower and upper threshold and not reducing said wing flex correction factor when the determined airspeed is above said upper threshold.

24. The method of claim 20 further including:
providing a second magnetometer mounted in a second wing different from said at least one wing, said second magnetometer adapted to sense the Earth's magnetic field and output a second navigation signal relating to a strength of the Earth's magnetic field;
defining a second magnetometer frame of reference fixed with respect to said second magnetometer; and
transforming said second navigation signal from the second magnetometer frame of reference to the body frame of reference using a second wing flex correction factor, said second wing flex correction factor accounting for flexing of said second wing with respect to said body, said second wing flex correction factor being determined prior to said aircraft becoming airborne.

25. The method of claim 24 further including:
determining a difference between said navigation signal and said second navigation signal after said navigation signal and said second navigation signal have been transformed to the body frame of reference;
changing said wing flex correction factor and said second wing flex correction factor if said difference is greater than zero; and
leaving unchanged said wing flex correction factor and said second wing flex correction factor if said difference is zero.

26. The method of claim 25 wherein said changing of said wing flex correction factor and said second wing flex correction factor is limited to changes that do not exceed a predetermined maximum.

27. The method of claim 20 further including providing a second magnetometer mounted in a second wing of the aircraft different from said at least one wing and adapted to output a second navigation signal relating to the Earth's magnetic field, averaging said navigation signal and said second navigation signal together to create an averaged signal, and computing the heading of the aircraft using said averaged signal.

28. A heading reference system for an aircraft having a body and at least one wing attached to said body, said system comprising:
a magnetometer mounted in the at least one wing of the aircraft, said magnetometer adapted to sense the Earth's magnetic field and output a signal relating to a strength of the Earth's magnetic field, said magnetometer defining a frame of reference fixed with respect to said magnetometer; and
a controller adapted to transform said signal from the magnetometer frame of reference to a body frame of reference using a wing flex correction factor, said body frame of reference being fixed with respect to the body of said aircraft, said wing flex correction factor accounting for flexing of said at least one wing with respect to said body, and said wing flex correction factor being determined prior to said aircraft becoming airborne.

29. The system of claim 28 wherein said wing flex correction factor includes both a non-zero pitch component and a non-zero roll component.

30. The system of claim 28 further including a sensor adapted to determine an airspeed of said aircraft wherein said controller adjusts said wing flex correction factor based upon the determined airspeed.

31. The system of claim 30 wherein said controller adjusts said wing flex correction factor based upon the determined airspeed by reducing said wing flex correction factor when the determined airspeed is at or between a lower and an upper threshold and by not reducing said wing flex correction factor when the determined airspeed is above said upper threshold.

32. The system of claim 28 further including a second magnetometer mounted in a second wing different from said at least one wing, said second magnetometer adapted to sense the Earth's magnetic field and output a second signal relating to a strength of the Earth's magnetic field, said second magnetometer defining a second magnetometer frame of reference fixed with respect to said second magnetometer, wherein said controller transforms said second signal from the second magnetometer frame of reference to the body frame of reference using a second wing flex correction factor, said second wing flex correction factor accounting for flexing of said second wing with respect to said body, said second wing flex correction factor being determined prior to said aircraft becoming airborne.

33. The system of claim 32 wherein said controller determines a difference between said signal and said second signal after said signal and said second signal have been transformed to the body frame of reference; changes said wing flex correction factor and said second wing flex correction factor if said difference is greater than zero; and leaves unchanged said wing flex correction factor and said second wing flex correction factor if said difference is zero.

34. The system of claim 33 wherein said controller changes said wing flex correction factor and said second wing flex correction factor by an amount no greater than a predetermined maximum.
